(19) United States
(12) Patent Application Publication
(10) Pub. No.: US 2006/0215616 A1
(43) Pub. Date: Sep. 28, 2006

(54) Device for data carrier detection

(76) Inventor: Walter Lechner, Wals (AT)

Correspondence Address: FLYNN THIEL BOUTELL & TANIS, P.C., 2026 RAMBLING ROAD, KALAMAZOO, MI, 49008-1631, US

(21) Appl. No.: 11/388,214

(22) Filed: Mar. 23, 2006

(30) Foreign Application Priority Data
Mar. 24, 2005 (EP) 05006516.8

(51) Int. Cl. H04B 7/216

(52) U.S. Cl. 370/335

(57) ABSTRACT

A device for detection of the lateral position of a data carrier (2, 3) has a scanning unit (1) to read out data deposited on the data carrier by means of radio-frequency signals. For the detection of the position of the data carrier (2, 3) on the one or other side of an antenna pair (A1, A2), the scanning unit (1) has a circuit to determine the modulation depth (T1, T2) of the signals received from the data carrier (2, 3) by the two partial antennae (A1, A2).

The invention refers to a device for the detection of the lateral position of a data carrier, in particular for passage and access control in accordance with the generic term of Claim 1.

In this type of device an automatic scanning unit checks the data carrier of the person passing, whereby access, which is usually blocked by a turnstile, is granted on scanning of a valid access authorization.

So-called RFID transponders are usually used as data carriers. These are described in more detail, for example, in: Klaus Finkenzeller, “RFID-Handbuch”, 1998, Carl Hanser Verlag Munich-Vienna. The RFID transponder can, for example, be integrated in a card or in a wristwatch or some similar object carried by a person. The energy supply to the data carrier as well as the data exchange are based on electromagnetic fields. An RFID transponder consists of a microchip and a coupling element, for example a coil or an antenna, which receives the energy transmitted by the scanning unit which is required to run the transponder. RFID transponders generally work with a carrier frequency of 125 kHz or 13.56 MHz. The data stored in the transponder are read out by means of an antenna in the form of a conductor loop which is connected to the scanning unit.

In the case of leisure facilities such as ski lifts or cable cars, or for access to large events, for example in sports stadia, as well as trade fairs or other facilities with large crowds, there are usually a number of access channels alongside each other, each with an antenna, a scanning unit and a blocking and/or indicator device.

Due to the relatively short distance between the antennae there is mutual interference which can cause a malfunction, for example, an access channel is opened without any authorization being provided for this.

In order to eliminate this mutual interference, the state of the art provides a metallic screen between the two antennae between two access channels. Due to the eddy currents generated in the metallic screening, the scanning range is considerably reduced. To reduce these eddy currents, the state of the art provides a ferrite material between the screen and the antenna. This, however, is quite complicated and only partially eliminates the reduction of the scanning range.

Thus the task of the invention its to provide a reliable detection of the position of a data carrier in a simple, uncomplicated manner.

This is achieved by the invention with the device described in claim 1. The sub-claims represent preferred embodiments of the invention.

According to the invention the scanning unit is provided with a circuit with which the modulation depth of the signals received by the two partial antennae is determined. The invention can be used, for example, for an access control device with a number of access channels, whereby the two partial antennae are each arranged between two access channels. With the two partial antennae allocated to one or the other access channel, it can then be established whether the data carrier is on the one or the other access channel.

This means that the data carrier, for example in the form of an REID transponder, is excited by a carrier frequency of, for example, 125 kHz or 13.56 MHz and the signals read out of the data carrier memory are modulated up to the carrier frequency. The degree or depth of the modulation generated by the RFID data carrier is reduced in inverse proportion to the distance between the partial antennae and the data carrier. This means that in the partial antenna with the shorter distance from the data carrier, the modulation depth is greater than in the partial antenna arranged alongside it and allocated to the other access channel.

By comparison of the modulation depths of the signals received by the two antennae, it can be determined at which access channel the data carrier is located. When the scanning unit reads a valid access authorization, it triggers the blocking and/or indicator device of the corresponding access channel to allow access. The blocking device can be, for example, a turnstile, or the indicator device a traffic light or similar optical indication. In particular, a rotary star configuration with inclined axis of rotation can be used for a turnstile.

To compare the modulation depths, the signals received from the two partial antennae can each be led into the microchip of the scanning unit via an input filter with amplifier.

In the simplest case, a conventional scanning unit with transmission/reception electronics and a transmission/reception antenna can be used to read the authorization data from the data carrier. Alongside the transmission/reception antenna of the scanning unit, a second antenna can also be provided which also receives the output signals of the data carrier as a pure reception or intercept antenna. By comparing the modulation depth of the signals received by the two antennae, the location of the data carrier on the one or other access channel is then determined. Instead of a reception or intercept antenna alongside the transmission/reception antenna, two intercept antennae can also be provided on both sides of the transmission/reception antenna, whereby the modulation depths of the signals received from the two intercept antennae are compared with each other.

It is preferable, however, to use a scanning unit with two partial transmission/reception antennae arranged alongside each other. The transmission/reception antenna and the reception or intercept antenna or the two intercept antennae or the two partial transmission/reception antennae can be activated alternately in time division multiplex mode in order to prevent interference by magnetic coupling. The multiplex operation, however, slows down the detection of the position of the data carriers. The scanning range is also impaired at the specified transmission output.

Preferably, therefore, and in accordance with the invention, the two partial transmission/reception antennae of the scanning unit are operated in such a way that the scanning unit transmits output signals in phase opposition, whereby the two partial antennae are in opposition to each other, or that it transmits co-phasal output signals with partial antennae oriented in the same direction.

The partial antennae are preferably formed by a conductor loop. The partial antennae oriented in opposition are designed in such a way that at a certain time the current is flowing in the one conductor loop in the one direction and in the other conductor loop in the opposite direction. With partial antennae oriented in the same direction, the current flows in both partial antennae in the same direction.

In order to generate counter-phasal output signals with the scanning unit, one of the two antenna drivers can be an inverted antenna driver.

If the scanning unit transmits counter-phasal output signals with the two partial antennae oriented in opposite directions, or co-phasal signals when the two partial antennae are oriented in the same direction, there is practically an addition of the fields generated by the two partial antennae. This substantially increases the scanning range.

In order to achieve a maximum addition of the fields generated by the two partial antennae, the distance between the partial antennae should be as small as possible. On the other hand, the greater the distance between the two partial antennae, the greater the difference in the modulation depth. The distance should thus be at least 1 mm and no greater than half the antenna diameter. Preferably the distance between the partial antennae should be 3 mm to 3 cm.

In order that the difference of the modulation depth of the signal received from both partial antennae is reliably registered, the two partial antennae should, as far as possible, be identical. As far as possible the conductor loops should run parallel to each other. Equally, the antenna drivers and the input filters with amplifier should, as far as possible, have the same characteristics.

For the device according to the invention, very simply structured, low-cost conductor loops can be used as partial antennae. The conductor loop can, for example, be printed on a foil. The partial antennae may also be print antennae or wire loop antennae. The partial antennae may also be made of coaxial cable.

In order to compensate for imperfect symmetry of the two antenna driver phases, the two partial antennae, the two input filters with amplifier and/or diverse other influences such as temperature, humidity, component tolerances and component ageing, it is advantageous to trigger the two partial antennae alternately with the two antenna drivers.

By switching the first driver phase from the first partial antenna to the second partial antenna, and switching of the second driver phase from the second partial antenna to the first partial antenna, the difference of the modulation depth in the two switch positions can be measured, whereby deviations in the hardware and other influences can be compensated.

As data carriers the invention preferably uses normal anti-collision RDID data carriers, i.e. data carriers which are not read simultaneously, but successively. This ensures that there is no conflict if two data carriers are located in the area of the partial antenna allocated to the respective access channel.

If, however, anti-collision RFID data carriers are not used, two successively arranged partial antenna pairs from each of the two antennae connected to the scanning unit and allocated to the one or other access channel can be placed alongside each other. A scanning mark is provided on the one antenna on the front pair allocated to the one access channel and a scanning antenna on the antenna on the rear pair allocated to the other access channel. Both partial antenna pairs are activated alternately in time division multiplex operation.

However, the invention is not only suitable for use in an access control system with at least two access channels alongside each other, but also, for example, in an access control device in both access directions. Such bidirectional access control systems are used, for example, to control persons entering and leaving a building or grounds at trade fairs, events or in leisure facilities such as museums, swimming pools, leisure parks or the like. The access/egress point is provided with a blocking device and/or indicator device.

The device in accordance with the invention detects whether the data carrier is located before the one partial antenna in the one access direction, e.g. towards the entrance or before the other partial antenna in the other direction, e.g. the exit. The user can hold the data carrier on the one or the other side of the two partial antennae. If a valid authorization to enter or leave is read by the scanning unit, the blocking device/indicator device opens to allow passage in the corresponding direction.

The invention is explained in more detail below with the aid of the enclosed drawings. The drawings show:

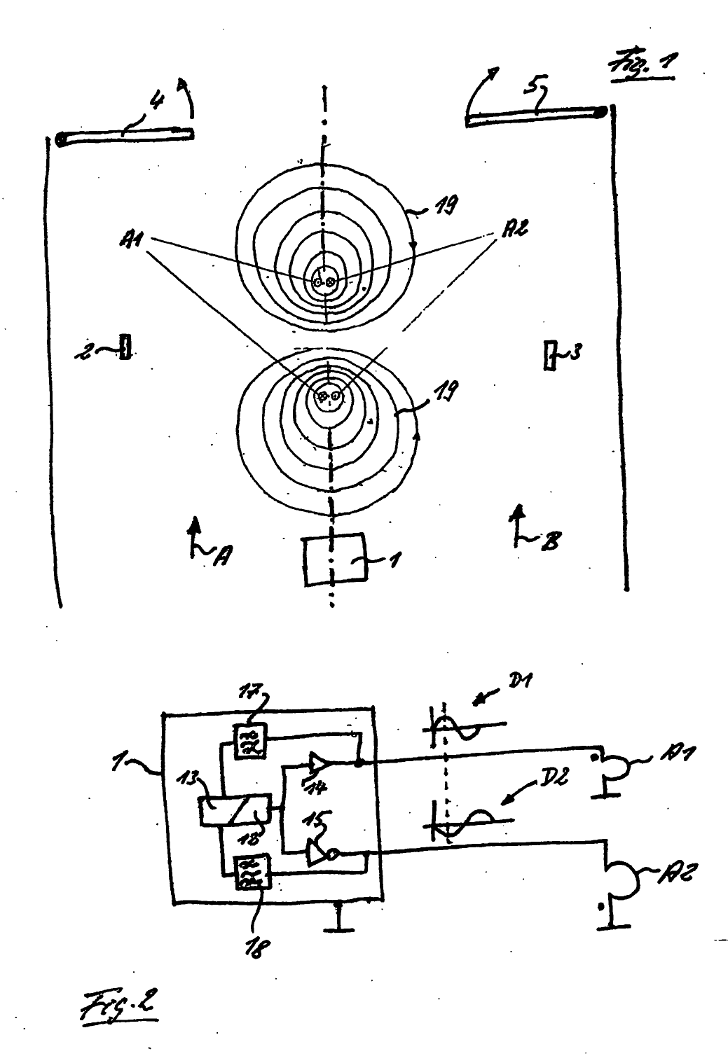

FIG. 1 a plan view of an entrance with two access channels, whereby the partial antenna are shown in section;

FIG. 2 circuit diagram for the access control system;

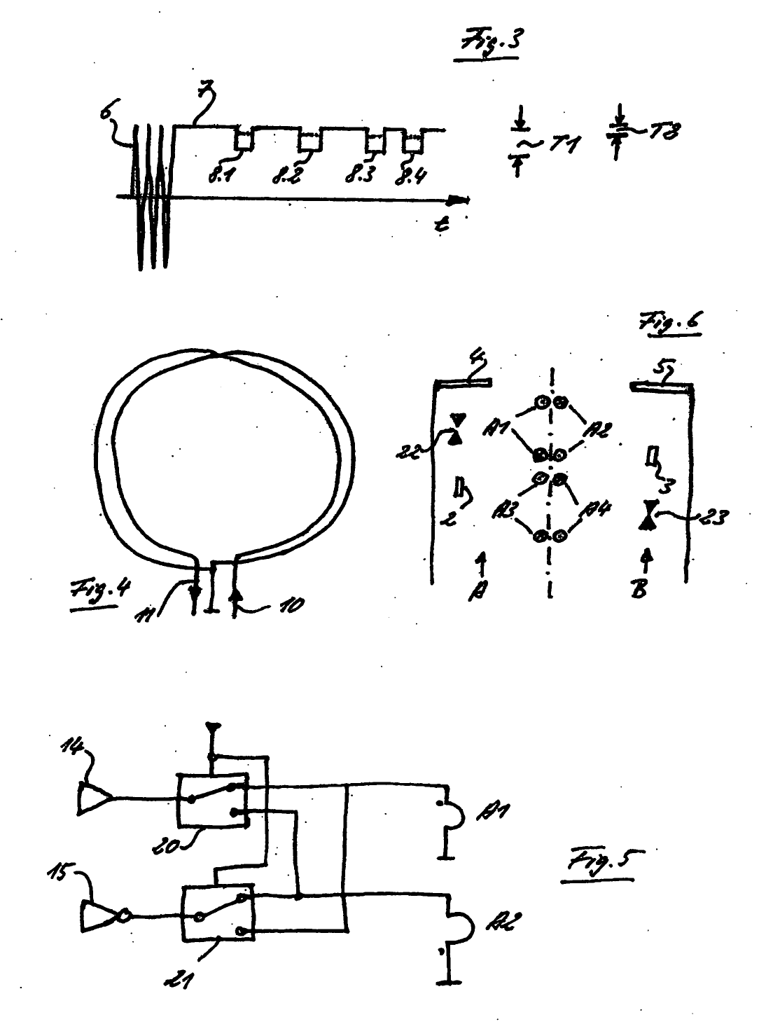

FIG. 3 a diagram of the carrier frequency with modulated signals;

FIG. 4 a side view of the two partial antenna in accordance with FIG. 1;

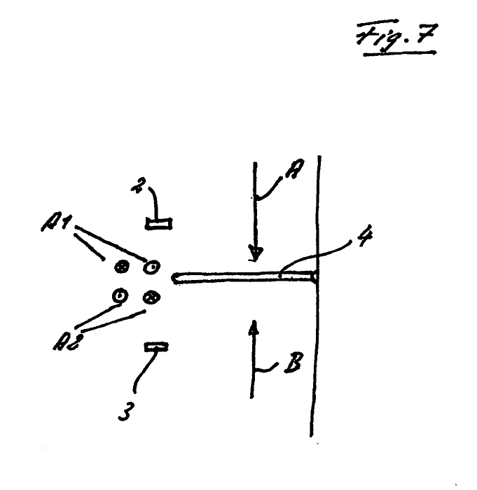

FIG. 5 a variation of the circuit arrangement in accordance with FIG. 2;

FIG. 6 a plan view of an entrance in accordance with FIG. 1, but for non-anti-collision RFID data carriers; and

FIG. 7 a plan view of a bidirectional passage control system.

FIG. 1 shows an entrance with two access channels A and B. Between the two access channels A and B there are two partial antennae A1 and A2 arranged alongside each other, each formed by a conductor loop shown in section in FIG. 1.

The partial antenna A1 is pointed at the access channel A and the partial antenna A2 at the access channel B. The partial antennae A1 and A2 are connected to a scanning unit 1.

When the scanner verifies the authorization of a data carrier 2 in the form of an RFID transponder on the access channel A or of a data carrier 3 in the form of an RFID transponder on the access channel B, the turnstile 4 or 5 is triggered to allow access through A or B respectively.

The partial antennae A1, A2 are in the form of transmission/reception antennae. With the radio-frequency field of the partial antennae A1 and A2, the RFID transponder 2 or 3 on the access channels A or B is excited with a certain carrier frequency of, for example 13.56 MHz, whereby the signals read out of the memory of the RFID transponder 2 or 3 are modulated up to the carrier frequency and received by the partial antennae A1 and A2.

In FIG. 3 the carrier frequency is shown on the left with a number of vibrations 6 and otherwise as envelope 7, as well as the signals 8.1, 8.2 etc. which are generated, for example, by attenuation and modulated up to the carrier frequency and received by the transponder 2 of partial antenna Al.

The modulation depth of the signals received from the transponder 2 with the partial antenna A1 is shown in FIG. 3 as T1. FIG. 3 also shows in broken lines the signals of transponder 2 modulated up to the carrier frequency and received by the partial antenna 2, whereby these have a lower modulation depth T2. Due to the greater modulation depth T1 on reception by the partial antenna A1 allocated to access channel A compared with the modulation depth T2 on reception by the partial antenna A2, a data carrier 2 read out on the access channel A is detected. If the read out signals correspond to an access authorization, the turnstile 4 is opened. If, on the other hand, the signals received by partial antenna A2 have a greater modulation depth than those of partial antenna A1, a data carrier 3 is detected on the access channel and, in the case of a valid authorization, the turnstile 5 is opened.

In FIGS. 1 and 4 the two partial antennae A1 and A2 are oriented in opposite directions. In FIG. 1 the symbol ⊙ designates a current traveling upwards and the symbol \textcircled{x} as a current traveling downwards, whereby this representation only applies on observation of a certain point in time due to the alternating field. In FIG. 4 the opposed direction of current flow is represented by the arrows 10 and 11. FIG. 4 also shows that the two conductor loops A1 and A2 which form the antenna are otherwise identical.

FIG. 2 shows that the scanning unit 1 has a transmission/reception electronic circuit 12 and 13. The two driver phases 14 and 15 for the partial antennae A1 and A2 are connected to the transmission electronics 12. The driver phase 15 for the partial antenna A2 is in the form of an inverted driver phase, i.e. compared to the phase response represented in the diagram D1 in FIG. 2, the output signal of the inverted driver 15 in accordance with diagram D2 is in the opposite direction.

According to the so-called right hand rule, the magnetic fields generated by the two partial antennae A1 and A2 are added as shown in FIG. 1 by the field lines 19.

In order to determine the different modulation depth T1 and T2 of the signals received by the two partial antennae A1 and A2, the partial antennae A1 and A2 are each connected via an input filter 17 and 18 with amplifier to the reception electronics 13, whereby the signals from the two partial antennae A1 and A2 are led from the input filter 17 and 18 with amplifier to the microprocessor (not shown) of the transmission/reception electronics 12 and 13.

In order to compensate for imperfect symmetry of the two driver phases 14 and 15, the two partial antennae A1 and A2, the two input filters 17 and 18 and diverse other variable influences, the two partial antennae A1 and A2 can be triggered in accordance with FIG. 5 by switches 20 and 21 alternately from the two antenna drivers 14 and 15.

FIG. 6 shows an entrance with two access channels A and B for non-anti-collision RFID transponders 2 and 3.

Two partial antennae A1, A2 and A3, A4 are arranged behind each other. The partial antennae A1 and A3 are allocated to the access channel A and the partial antennae A2 and A4 to the access channel B. The scanning mark 22 shown in FIG. 6 as a double arrow is provided at the partial antenna A1 allocated to the access channel A, and the scanning mark 23 on the partial antenna A4 arranged before it on the access channel B. The two partial antenna pairs A1, A2 and A3, A4 are activated alternately in time division multiplex operation.

If there is a collision of the two data carriers 2 and 3, neither the locking device 4 nor 5 will be opened. The user at the access channel A then holds the data carrier 2 at the marking 22 on the front pair of partial antennae A1 and A2 and the user of access channel B at the marking 23 on the rear pair of partial antennae A3 and A4. As the two partial antenna pairs A1, A2 and A3, A4 are not read simultaneously due to the time division multiplex operation, there can be no collision of the data carriers 2 and 3. This means that if both data carriers 2 and 3 have access authorization, the turnstiles 4 and 5 will open successively.

In FIG. 7 a passage is passable in two directions A and B. The direction A leads, for example, to the entrance and the direction B to the exit of, for example a building. A locking device 4 is provided in the passage, for example a turnstile. There is an antenna pair A1, A2 at turnstile 4. Partial antenna A1 is on the side pointing towards the direction of passage A and antenna A2 on the side pointing towards the direction of passage B. In accordance with the invention it can thus be established whether the data carrier 2 is before the partial antenna A1 and a user is moving in the direction of passage A or the data carrier 3 is before the partial antenna A2 and the user is moving in the direction of passage B.

If the scanning unit not shown in FIG. 1 reads a valid authorization for entrance or exit on the data carrier 2 or 3, passage is allowed in the corresponding direction of passage, i.e. the turnstile 4 can be turned in the corresponding direction of passage A or B.

1. Device for the detection of the lateral position of a data carrier (2, 3) with a scanning unit (1) to read data deposited on the data carrier by radio-frequency signals and characterized in that for the detection of the position of the data carrier (2, 3) on one or the other side there is at least one pair of antennae consisting of two partial antennae (A1, A2), which are connected to the scanning unit (1), whereby the scanning unit (1) has a circuit for determination of the modulation depth (T1, T2) of the signals received by the two partial antennae (A1, A2) from the data carrier (2, 3).

2. Device in accordance with claim 1 for a passage with blocking and/or indicator devices and characterized in that to control passage in both directions (A, B) at least one pair of antennae (A1, A2) is provided for detection of the data carrier (2, 3) before the two partial antennae (A1, A2) in the one direction of passage (A) or the other direction of passage (B).

3. Device in accordance with claim 1 for access control with access authorizations stored on non-contact data carriers (2, 3) with at least two access channels (A, B) between which at least two partial antennae (A1, A2), which are allocated to one or the other access channel (A, B) and connected to a scanning unit (1), are arranged alongside each other and which check the data carrier (2, 3) by means of radiofrequency fields, and with blocking and/or recognition means (4, 5), which allow access through the respective access channel (A, B) on confirmation of access authorization by the scanning unit (1) and characterized in that for the detection of the position of the data carrier (2, 3) on one or other of the access channels (A, B) the scanning unit (1) has a circuit for determination of the modulation depth (T1, T2) of the signals received by the two partial antennae (A1, A2).

4. Device in accordance with claim 1 characterized in that the scanning unit (1) has a microprocessor to determine the different modulation depths (T1, T2) of the signals received by the two partial antennae (A1, A2).

5. Device in accordance with claim 1 characterized in that the signals received by the two partial antennae (A1, A2) can be led into the microprocessor of the scanning unit (1) via an input filter (17, 18) with amplifier.

6. Device in accordance with claim 1 characterized in that the scanning unit (1) has an electronic transmission/reception system (12, 13).

7. Device in accordance with claim 1 characterized in that the two partial antennae (A1, A2) can be activated alternately in time division multiplex operation.

8. Device in accordance with claim 1 characterized in that the data carriers (2, 3) are in the form of anti-collision data carriers.

9. Device in accordance with claim 3 characterized in that if non-anti-collision data carriers (2, 3) are used, two partial antenna pairs arranged behind each other are provided from two partial antennae (A1, A2 and A3, A4) which are arranged alongside each other and allocated to the one or other access channel (A, B) and connected to the scanning unit (1), and a scanning mark (22) is provided at the one access channel (A) at the one partial antenna pair (A1, A2) and a scanning mark (23) is provided on the other access channel (B) on the other partial antenna pair (A3, A4) and the two partial antenna pairs (A1, A2 and A3, A4) can be activated alternately in time division multiplex operation.

10. Device in accordance with claim 1 characterized in that the scanning unit (1) can send counter-phasal output signals when the two partial antennae (A1, A2) are oriented in opposition and co-phasal output signals when the two partial antennae (A1, A2) are oriented in the same direction.

11. Device in accordance with claim 8 characterized in that the scanning unit (1) for each partial antenna (A1, A2) has an antenna driver (14, 15) and one of the two antenna drivers (14, 15) is designed as an inverted antenna driver (15) to generate counter-phasal output signals.

12. Device in accordance with claim 11 characterized in that the scanning unit (1) has a circuit with which the two partial antennae (A1, A2) can be triggered alternately from the two antenna drivers (14, 15).

13. Device in accordance with claim 1 characterized in that the distance between the two partial antennae (A1, A2 and A3, A4) arranged beside each other is at least 1 mm.

14. Device in accordance with claim 1 characterized in that the distance between the two partial antennae (A1, A2 and A3, A4) arranged beside each other is no greater than half the antenna diameter.

15. Device in accordance with claim 1 characterized in that each partial antennae is formed by a conductor loop.
